(19) United States
(12) Patent Application Publication
(10) Pub. No.: US 2002/0104409 A1
(43) Pub. Date: Aug. 8, 2002

(54) Rotary wrenching tool

(76) Inventor: Bobby Hu, Taichung (TW)

Correspondence Address: Alan D. Kamrath, Esquire, 333 South 7th Street, Suite 2000, Minneapolis, MN, 55402, US

(21) Appl. No.: 09/734,932

(22) Filed: Dec. 11, 2000

(51) Int. Cl. B25B 13/00

(52) U.S. Cl. 81/124.3

(57) ABSTRACT

A rotary wrenching tool includes a handle and a head having an opening defined therein for receiving a polygonal head of a fastener. An inner periphery defining the opening includes a plurality of annularly spaced grooves defined therein, wherein each two adjacent grooves are connected by a connecting section. Each connecting section includes a first operative section having an end connected to one of the two adjacent grooves and forming a side of the one of the two adjacent grooves, a second operative section having an end connected to the other of the two adjacent grooves and forming a side of the other of the two adjacent grooves, and an inoperative section interconnected between the first operative section and the second operative section. The first operative sections or the second operative sections engage with the fastener to be wrenched, and each inoperative section does not engage with the fastener to be wrenched. The inoperative section may be rectilinear or convex, i.e., curved outward towards the outer periphery of the wrench head. Each inoperative section includes two ends each of which terminates at a critical point adapted to engage with a face of the fastener in which the rotary wrenching tool has been rotated through a free rotational angle.

### Background of the Invention

The present invention relates to a rotary wrenching tool which is capable of, in a limited space, wrenching (i.e., loosening or tightening) fastener heads designed, sized, or marked in various measuring systems such as the metric system and inch system.

Currently, there are two commonly used measuring systems in the world: the metric system and the inch system. Thus, hand tools (such as wrenches, spanners, etc.) and fasteners (such as bolts, screws, nuts, etc.) have different nominal size systems with which users are troubled. U.S. Pat. Nos. 5, 219,392 and 5,388,486 both to Ruzika et al. disclose a rotary wrenching tool with two nominal sizes marked thereon for “wrenching” fastener heads of various nominal size systems. However, it is found that a considerable free rotational angle (backlash) exists in such a rotary wrenching tool, i.e., after engaging the rotary wrenching tool (e.g., in the form of a ring spanner) with a fastener head, the spanner has to be rotated through a considerable angle before it reliably engages and thus “wrenches” the fastener head. This is extremely inconvenient when working in a limited space. The problem of backlash is aggravated if the rotary wrenching tool is a socket wrench.

### Summary of the Invention

A rotary wrenching tool in accordance with the present invention includes a handle and a head having an opening defined therein for receiving a polygonal head of a fastener. An inner periphery defining the opening includes a plurality of annularly spaced grooves defined therein, wherein each two adjacent grooves are connected by a connecting section. Each connecting section includes a first operative section having an end connected to one of the two adjacent grooves and forming a side of the one of the two adjacent grooves, a second operative section having an end connected to the other of the two adjacent grooves and forming a side of the other of the two adjacent grooves, and an inoperative section interconnected between the first operative section and the second operative section. The first operative sections or the second operative sections engage with the fastener to be wrenched, and each inoperative section does not engage with the fastener to be wrenched.

The inoperative section may be rectilinear or convex, i.e., curved outward towards the outer periphery of the wrench head. Each inoperative section includes two ends each of which terminates at a critical point adapted to engage with a face of the fastener in which the rotary wrenching tool has been rotated through a free rotational angle. By such a provision, the rotary wrenching tool in accordance with the present invention has a relatively smaller free rotational angle when compared with the prior art rotary wrenching tools.

Other objects, advantages, and novel features of the invention will become more apparent from the following detailed description when taken in conjunction with the accompanying drawings.

### Brief Description of the Drawings

FIG. 1 is a perspective view of a rotary wrenching tool in accordance with the present invention which has a difference of 0.05 mm between two nominal sizes of different nominal size systems marked thereon.

FIG. 2 is a schematic view of a rotary wrenching tool in accordance with the present invention which has a difference of 0.1 mm between two nominal sizes of different nominal size systems marked thereon.

FIG. 3 is a schematic view of a rotary wrenching tool in accordance with the present invention which has a difference of 0.3 mm between two nominal sizes of different nominal size systems marked thereon.

FIG. 4 is a schematic view of a rotary wrenching tool in accordance with the present invention which has a difference of 0.5 mm between two nominal sizes of different nominal size systems marked thereon.

FIG. 5 is a schematic view of a prior art rotary wrenching tool which has a difference of 0.05 mm between two nominal sizes of different nominal size systems marked thereon.

FIG. 6 is a schematic view of a prior art rotary wrenching tool which has a difference of 0.1 mm between two nominal sizes of different nominal size systems marked thereon.

FIG. 7 is a schematic view of a prior art rotary wrenching tool which has a difference of 0.3 mm between two nominal sizes of different nominal size systems marked thereon.

FIG. 8 is a schematic view of a prior art rotary wrenching tool which has a difference of 0.5 mm between two nominal sizes of different nominal size systems marked thereon.

### Detailed Description of the Preferred Embodiments

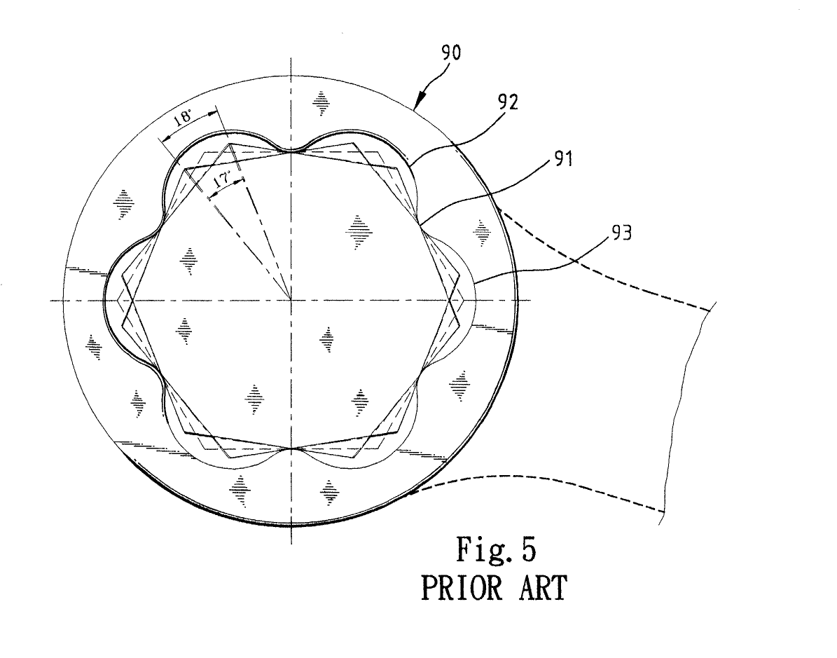

For a better understanding of the background of the invention, reference is firstly made to FIGS. 5 through 8 which illustrate prior art rotary wrenching tools (in the form of ring spanners for illustrative purpose) having dual nominal sizes marked thereon and constructed according to the teaching of the above-mentioned U.S. Pat. Nos. 5,219,392 and 5,388,486 for wrenching fastener heads of different nominal size systems (e.g., the metric system and the inch system). Table 1 shows differences between the two nominal sizes marked thereon.

TABLE 1
dual nominal size spanner

| mm | inch | mm converted from inch | difference |
|---|---|---|---|
| 6 | 1/4 | 6.35 | 0.35 |
| 8 | 5/16 | 7.94 | 0.06 |
| 9 | 11/32 | 8.73 | 0.27 |
| 10 | 3/8 | 9.5 | 0.5 |
| 11 | 7/16 | 11.11 | 0.11 |
| 13 | 1/2 | 12.7 | 0.3 |
| 14 | 9/16 | 14.29 | 0.29 |
| 16 | 5/8 | 15.88 | 0.12 |
| 17 | 11/16 | 17.46 | 0.46 |
| 19 | 3./4 | 19.05 | 0.05 |

The difference between the metric nominal size and the inch nominal size is inevitable, e.g., a difference of 0.5 mm exists between 10 mm and ⅜ inches. Therefore, the dual nominal size spanner so constructed for both nominal sizes of different nominal size systems has an unavoidable free rotational angle.

Referring to FIG. 5, a prior art rotary wrenching tool includes a head 90 having an opening (not labeled) with a number of convex sections 92 and 93 defined therein, wherein each two adjacent sections 92 and 93 are connected via a concave section 91 which bears against a face of a fastener head (not labeled) to be loosened or tightened. However, the wrenching tool must be rotated through a relatively large free rotational angle before the concave sections 91 (which are relatively small) bear against the faces of the fastener head.

The prior art wrenching tool in FIG. 5 has a difference of 0.05 mm between two nominal sizes of different nominal size systems marked thereon, wherein a maximum free rotational angle thereof is seventeen (17) degrees for a small size fastener head or eighteen (18) degrees for a large size fastener head. If the wrenching tool is a socket wrench with, e.g., 72 teeth, the minimum free rotational angle will be the above-mentioned angle (17 or 18 degrees) plus five degrees (360/72=5), and, for a socket wrench with 36 teeth, the minimum free rotational angle will be the above-mentioned angle (17 or 18 degrees) plus ten degrees (360/36=10).

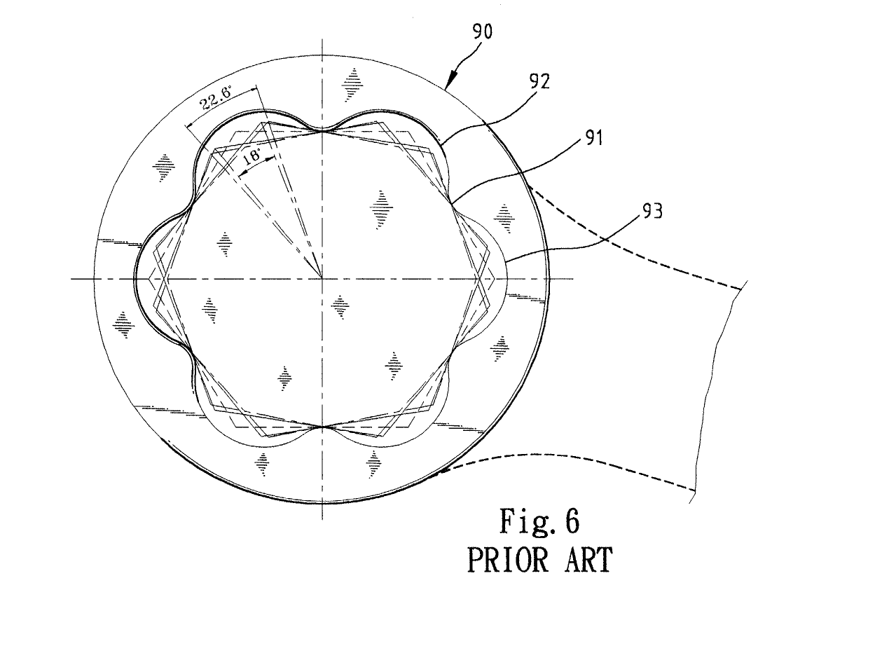

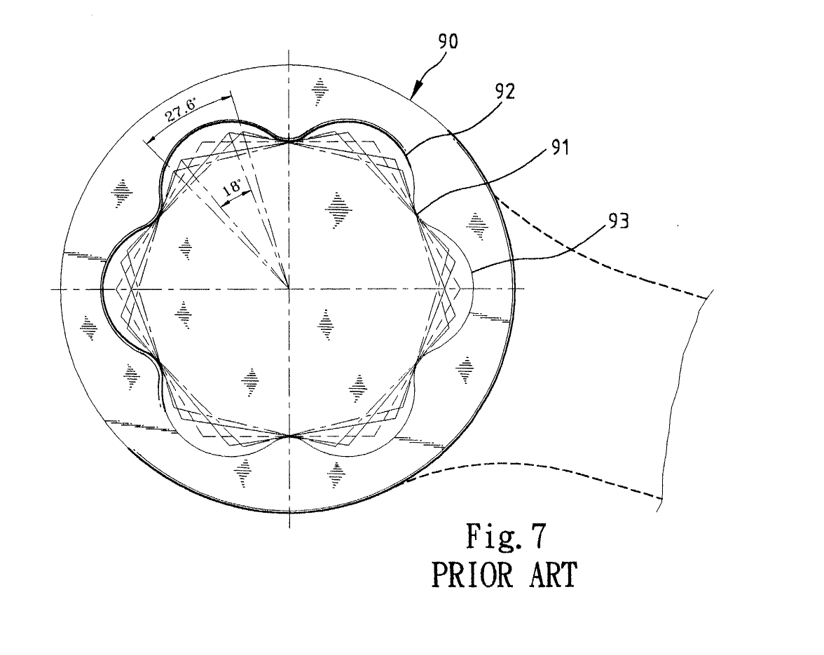

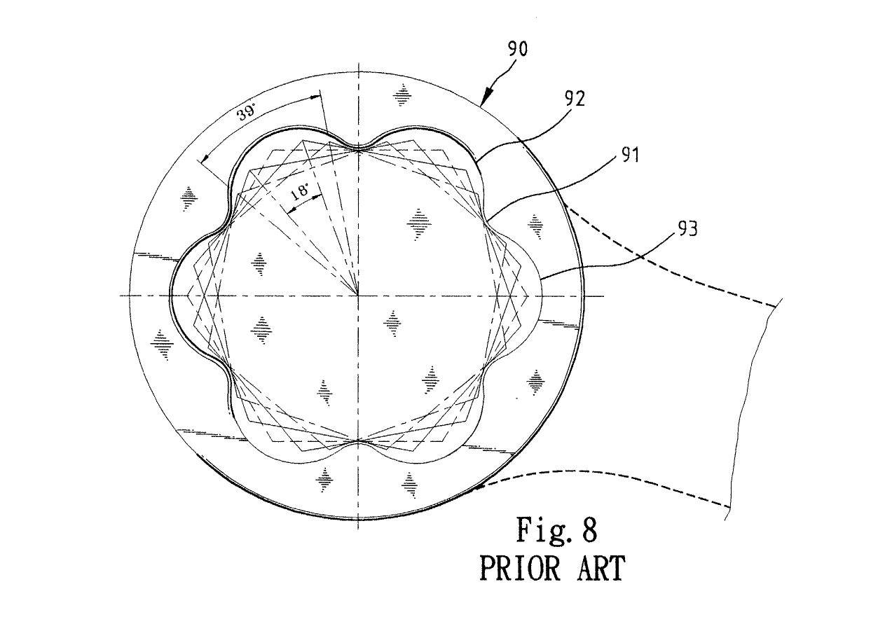

FIG. 6 shows a prior art wrenching tool which has a difference of 0.1 mm between two nominal sizes of different nominal size systems marked thereon, wherein a maximum free rotational angle thereof is eighteen (18) degrees for a small size fastener head or 22.6 degrees for a large size fastener head. FIG. 7 shows a prior art wrenching tool which has a difference of 0.3 mm between two nominal sizes of different nominal size systems marked thereon, wherein a maximum free rotational angle thereof is eighteen (18) degrees for a small size fastener head or 27.6 degrees for a large size fastener head. FIG. 8 shows a prior art wrenching tool which has a difference of 0.5 mm between two nominal sizes of different nominal size systems marked thereon, wherein a maximum free rotational angle thereof is eighteen (18) degrees for a small size fastener head or 39 degrees for a large size fastener head. If the wrenching tool is a socket wrench, further free rotational angle is required as mentioned in the above paragraph. Consequently, the prior art wrenching tool is inconvenient to use and sometimes even inoperable when in a limited space.

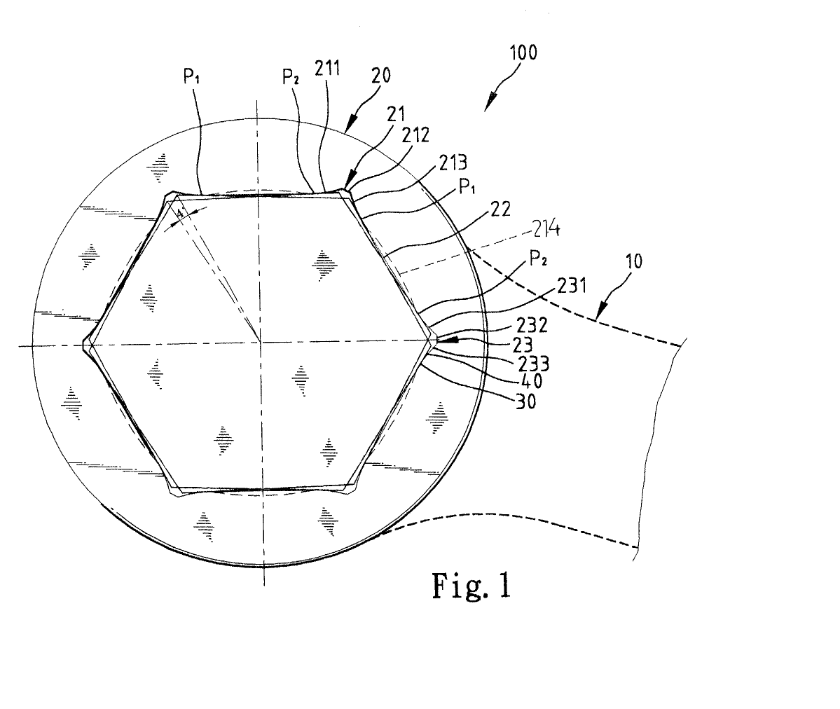

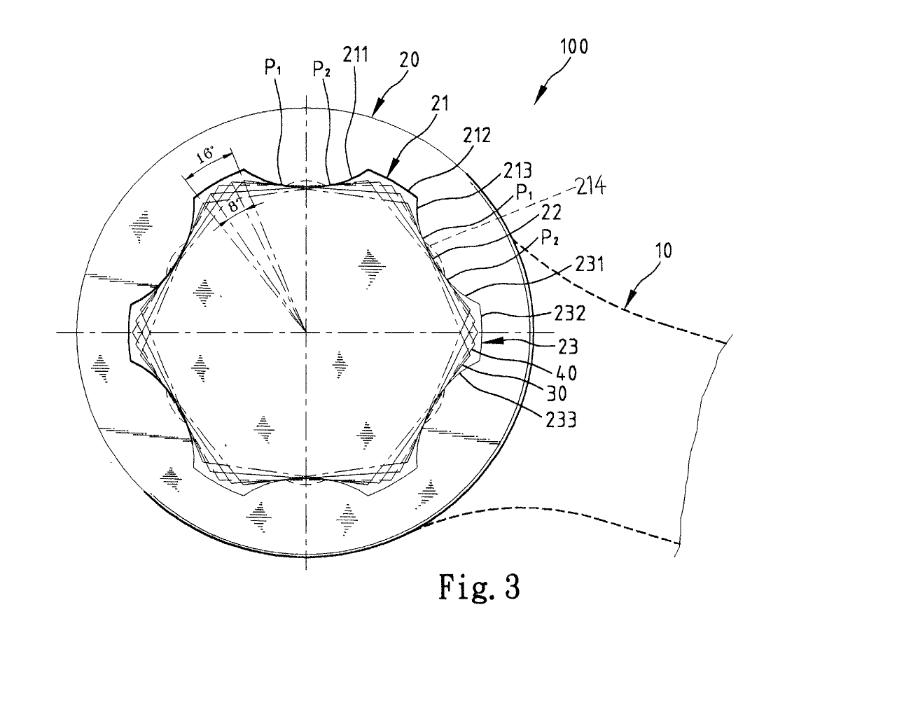

Now refer to FIGS. 1 through 4 which illustrate rotary wrenching tools in accordance with the present invention. For purpose of explanation, the rotary wrenching tool is illustrated as a ring spanner. It is, nevertheless, appreciated that the rotary wrenching tool can be of any other form, e.g., a socket wrench or the like. Referring to FIG. 3, the ring spanner, designated by reference numeral “100” includes a handle 10 and a head 20 having an opening (not labeled) defined therein for receiving a polygonal head of a fastener 30 (e.g., of an inch nominal size system) or fastener 40 (e.g., of a metric nominal size system). An inner periphery (not labeled) defining the opening includes a number of annularly spaced grooves 21, 23 defined therein, wherein each two adjacent grooves 21 and 23 are connected by a connecting section 22. Each connecting section 22 includes a first operative section 213 having an end connected to one of the two adjacent grooves (e.g., groove 21) and forming a side of the groove 21, a second operative section 231 having an end connected to the other of the two adjacent grooves (groove 23) and forming a side of the groove 23, and an inoperative section 214 connected between the first operative section 213 and the second operative section 231.

More specifically, the groove 21 includes a mediate section 212 which does not contact with the fastener 30, 40 and two sides (i.e., operative sections) 211 and 213 which contact with the fastener 30, 40, while the groove 23 includes a mediate section 232 which does not contact with the fastener 30, 40 and two sides (i.e., operative sections) 231 and 233 which contact with the fastener 30, 40. The operative section 213 and the operative section 231 joint with the inoperative section 214 at points P1 and P2, respectively. More specifically, the fastener 30, 40 does not contact with the inoperative section 214 defined between the two end points P1 and P2, which is quite different from the prior art tools shown in FIGS. 5 through 8 as well as any other prior art tools. Namely, each inoperative section 214 includes two ends each of which terminates at a critical point adapted to engage with a face of the fastener in which the rotary wrenching tool has been rotated through a free rotational angle. The inoperative section 214 may be rectilinear (see the solid lines) or convex, i.e., curved outwardly towards the outer periphery of the wrench head (see the phantom lines). In operation, the faces of the fastener 30, 40 bear against the operative sections 211, 213, 231, 233, etc. In addition, the inoperative section 214, if in a concave outline, has a maximum depth greater than a diagonal length of the fastener to be wrenched.

Referring to FIG. 3, when wrenching the fastener 30 (e.g., of ½ inches), if the spanner 100 is rotated clockwise through a free rotational angle, each face of the fastener 30 firstly bears against the associated operative section 231 at point P2, and further rotation of the spanner 100 causes the face of the fastener 30 to engage with the associated operative section 231. If the spanner 100 is rotated counterclockwise through a free rotational angle, each face of the fastener 30 firstly bears against the associated operative section 213 at point P1, and further rotation of the spanner 100 causes the face to engage with the associated operative section 213. Similarly, when wrenching the fastener 40 (e.g., of 13 inches), if the spanner 100 is rotated clockwise through a free rotational angle, each face of the fastener 40 firstly bears against the associated operative section 231 at point P2, and further rotation of the spanner 100 causes the face of the fastener 40 to engage with the associated operative section 231. If the spanner 100 is rotated counterclockwise through a free rotational angle, each face of the fastener 40 firstly bears against the associated operative section 213 at point P1, and further rotation of the spanner 100 causes the face to engage with the associated operative section 213. In other words, for both fasteners 30 and 40 of different nominal size systems, the points P1 and P2 are critical points which firstly engage with the faces of the fastener to be wrenched after having been rotating the spanner through the free rotational angle.

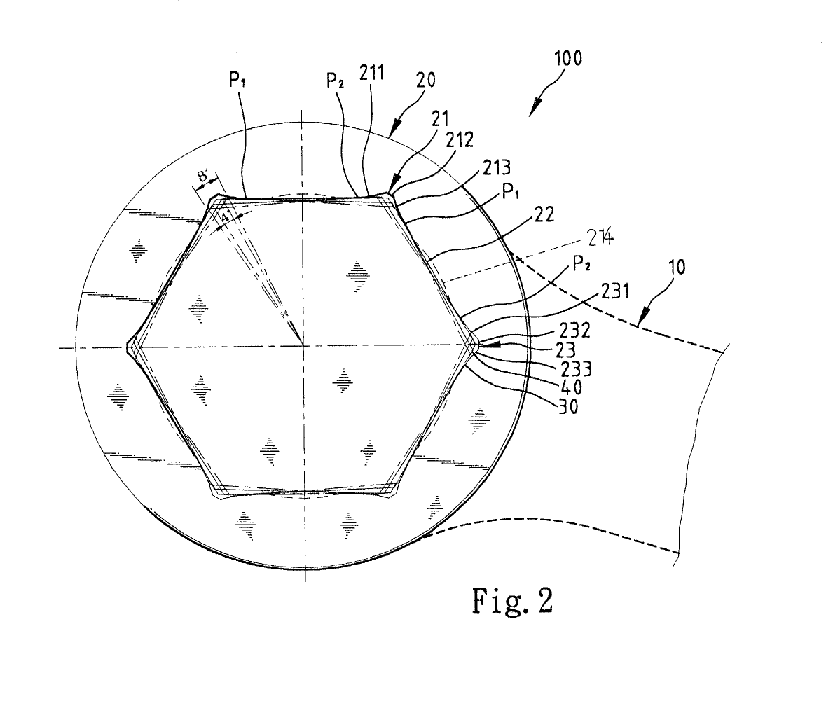

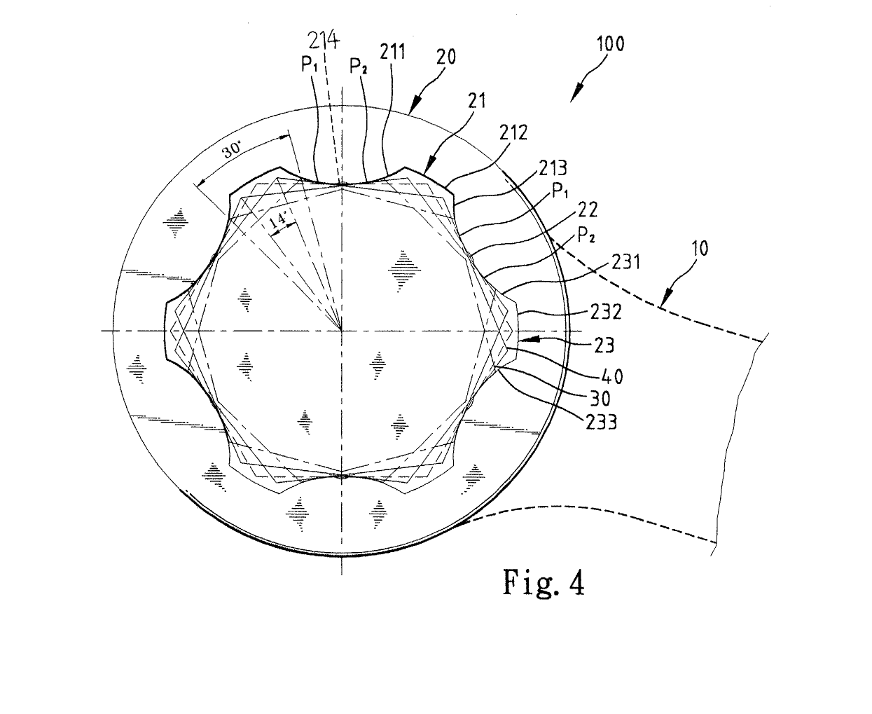

The ring spanner in FIG. 1 has a difference of 0.05 mm between two nominal sizes of different nominal size systems marked thereon, wherein a maximum free rotational angle thereof is four (4) degrees for both small size fastener head and large size fastener head. FIG. 2 shows a ring spanner in accordance with the present invention which has a difference of 0.1 mm between two nominal sizes of different nominal size systems marked thereon, wherein a maximum free rotational angle thereof is four (4) degrees for a small size fastener head or eight (8) degrees for a large size fastener head. FIG. 3 shows a ring spanner in accordance with the present invention which has a difference of 0.3 mm between two nominal sizes of different nominal size systems marked thereon, wherein a maximum free rotational angle thereof is eight (8) degrees for a small size fastener head or sixteen (16) degrees for a large size fastener head. FIG. 4 shows a ring spanner in accordance with the present invention which has a difference of 0.5 mm between two nominal sizes of different nominal size systems marked thereon, wherein a maximum free rotational angle thereof is fourteen (14) degrees for a small size fastener head or thirty (30) degrees for a large size fastener head. If the wrenching tool is a socket wrench, further free rotational angle is required as mentioned above. Referring to FIGS. 1 through 4, it is appreciated that the grooves 21, 23 of a spanner with a smaller nominal size difference (e.g., of 0.05 mm, see FIG. 1) is smaller than the grooves 21, 23 of a spanner with a larger nominal size difference (e.g., of 0.5 mm, see FIG. 4).

Difference between the prior art spanner and the spanner of the present invention in the free rotational angle is listed in Table 2:

TABLE 2

| free rotational angle | |
|---|---|
| prior art | the invention |

| size difference | 1* | 2* | 1* | 2* |
|---|---|---|---|---|
| 0.05 mm | 17° | 18° | 4° | 4° |
| 0.1 mm | 18° | 22.6° | 4° | 8° |
| 0.3 mm | 18° | 27.6° | 3° | 16° |
| 0.5 mm | 18° | 39° | 14° | 30° |

1* small size fastener head
2* large size fastener head

As can be seen from Table 2, the dual nominal size spanners constructed in accordance with the present invention have relatively smaller free rotational angles when compared with those of prior art dual nominal size spanners. As a result, the spanners in accordance with the present invention are advantageous when used in limited spaces.

Although the invention has been explained in relation to its preferred embodiment, it is to be understood that many other possible modifications and variations can be made without departing from the scope of the invention as hereinafter claimed.

What is claimed is:

1. A rotary wrenching tool, comprising a handle and a head having an opening defined therein adapted to receive a polygonal head of a fastener, an inner periphery which defines the opening including a plurality of annularly spaced grooves defined therein, each two adjacent said grooves being connected by a connecting section, each said connecting section including a first operative section having an end connected to one of the two adjacent grooves and forming a side of said one of the two adjacent grooves, a second operative section having an end connected to the other of the two adjacent grooves and forming a side of the other of the two adjacent grooves, and an inoperative section interconnected between the first operative section and the second operative section;
one of each said first operative section and each said second operative section engaging with the fastener to be wrenched, and each said inoperative section being rectilinear and not engaging with the fastener to be wrenched.

2. The rotary wrenching tool according to claim 1, wherein each said inoperative section includes two ends each of which terminates at a critical point adapted to engage with a face of the fastener in which the rotary wrenching tool has been rotated through a free rotational angle.

3. The rotary wrenching tool according to claim 1, wherein the rotary wrenching tool, in operation, has a free rotational angle less than 10° when used with fasteners of 8 mm, 11 mm, 19mm, 5/16″, 7/16″, or ¾″.

4. The rotary wrenching tool according to claim 1, wherein the rotary wrenching tool, in operation, has a free rotational angle less than 10° when used with fasteners of 11/32″ or ⅝″, and less than 20° when used with a fastener of 9 mm or 16 mm.

5. 1. A rotary wrenching tool, comprising a handle and a head having an opening defined therein adapted to receive a polygonal head of a fastener, an inner periphery which defines the opening including a plurality of annularly spaced grooves defined therein, each two adjacent said grooves being connected by a connecting section, each said connecting section including a first operative section having an end connected to one of the two adjacent grooves and forming a side of said one of the two adjacent grooves, a second operative section having an end connected to the other of the two adjacent grooves and forming a side of the other of the two adjacent grooves, and an inoperative section interconnected between the first operative section and the second operative section;
one of each said first operative section and each said second operative section engaging with the fastener to be wrenched, and each said inoperative section being curved outward towards the outer periphery of the wrench head and not engaging with the fastener to be wrenched.

6. The rotary wrenching tool according to claim 5, wherein each said inoperative section includes two ends each of which terminates at a critical point adapted to engage with a face of the fastener in which the rotary wrenching tool has been rotated through a free rotational angle.

7. The rotary wrenching tool according to claim 5, wherein the rotary wrenching tool, in operation, has a free rotational angle less than 10° when used with fasteners of 8 mm, 11 mm, 19 mm, 5/16″, 7/16″, or ¾″.

8. The rotary wrenching tool according to claim 5, wherein the rotary wrenching tool, in operation, has a free rotational angle less than 10° when used with fasteners of 11/32″ or ⅝″, and less than 20° when used with a fastener of 9 mm or 16 mm.
